(19) United States
(12) Patent Application Publication
(10) Pub. No.: US 2004/0152516 A1
(43) Pub. Date: Aug. 5, 2004

(54) Data delivery and management system and method for game machines

(75) Inventors: Karl T. Blatter, Rolling Meadows, IL (US); Randy S. Demsetz, Algonquin, IL (US); Peter G. Hallenberg, Chicago, IL (US); Lawrence J. Hodgson, Kildeer, IL (US); Andrew J. Kniaz, Chicago, IL (US); R. Scott Morrison, Mundelein, IL (US); Leonid Smikun, Glenview, IL (US)

Correspondence Address: WELSH & KATZ, LTD, 120 S RIVERSIDE PLAZA, 22ND FLOOR, CHICAGO, IL, 60606, US

(73) Assignee: Incredible Technologies, Inc., Arlington Heights (US)

(21) Appl. No.: 10/662,891

(22) Filed: Sep. 15, 2003

Related U.S. Application Data
(60) Provisional application No. 60/411,549, filed on Sep. 18, 2002.

(51) Int. Cl. A63F 13/00

(52) U.S. Cl. 463/42

(57) ABSTRACT

A system and method of organizing and administering contests or other promotions for physically dispersed currency, card, or ticket video games enable an organizer to conduct such contests or promotions from a single location. Software executable locally enables the organizer to define a contest, transmit contest or promotional information to the various video games, and stage the contest or promotion at a plurality of such games during a predetermined time interval. Contest results can be retrieved by the organizer at the location. The organizer can determine contest or promotion winners and transmit those results to the various video games.

The benefit of the filing date of Sep. 18, 2002 of U.S. Provisional Application No. 60/411,549 is hereby claimed.

### FIELD OF THE INVENTION

The invention pertains to management of contests or promotions where each participant competes against other participants. More particularly, the invention pertains to computer based systems and methods which assist in the management of such contests or promotions.

### BACKGROUND OF THE INVENTION

Systems are known for linking video games located in proximity to one another or spaced apart in separate locations to a common site via an electronic network. In a known implementation, access can be via the Internet over conventional telephone lines or other communication mediums including but not limited to wireless or satellite technology. A site on the network which is accessible to the various games can store game results player information, and other data. Contests including but not limited to tournaments, leagues, and other forms of competition involving numerous players using spaced apart games can be implemented using a data collection and storage facility at the common site.

Such networked contests provide advantages for players and for contest operators. Players get to participate with a much larger pool of players than might otherwise be possible. Contest operators have centralized access to all of the game results for the competition even though the various game machines might be distributed over a wide area.

Despite the above noted benefits and advantages, networked games are only on the verge of exploiting the capabilities of the networked configuration. There continues to be a need for more efficient, easy to use tournament creation and administration software.

### BRIEF DESCRIPTION OF THE DRAWINGS

FIG. 1 is a block diagram of a system which embodies the present invention;

FIG. 2 is an initial menu of operator options of the software tool of the invention;

FIG. 2A is a screen illustrating batches of newly received game play data;

FIG. 3 is a computer generated screen of contest criteria and date ranges of a pre-stored contest;

FIG. 4 is a computer generated set-up screen;

FIG. 5 is a computer generated screen for defining a new contest;

FIG. 5A is a computer generated screen for specifying characteristics of the new contest;

FIG. 6 is a computer generated screen for specifying dates and times of the new contest;

FIG. 7 is an exemplary computer generated screen enabling an operator to select one or more of a variety of golf courses for a golf tournament;

FIG. 8 is a computer generated screen enabling an operator to specify which of a plurality of game machines is to participate in the contest;

FIG. 9 is a computer generated screen enabling an operator to create a message to be transmitted to selected game machines;

FIG. 10 is a representation of a message, as in FIG. 9, presented at a game machine;

FIG. 11 is a computer generated screen enabling an operator to specify game types to be included in the contest;

FIG. 12 is a computer generated screen enabling the operator to specify various contest rules;

FIG. 13 is a computer generated screen enabling the operator to specify sort criteria;

FIG. 14 is a computer generated screen of contest data sorted in accordance with the criteria of FIG. 13;

FIG. 15 is a computer generated screen for establishing a leaderboard for display on one or more game machines;

FIG. 15A illustrates the leaderboard of FIG. 15 displayed at a game machine;

FIG. 16 is an overall block diagram of a process of defining a new contest; and

FIG. 16B is an overall block diagram of post-contest operations.

### DETAILED DESCRIPTION OF THE EMBODIMENTS

While embodiments of this invention can take many different forms, specific embodiments thereof are shown in the drawings and will be described herein in detail with the understanding that the present disclosure is to be considered as an exemplification of the principles of the invention and is not intended to limit the invention to the specific embodiment illustrated.

In a system which embodies the invention, contest creation and administration software can be executed on a processor in intermittent communication, via an electronic network, with a plurality of electronic games. The games communicate game playing information, via the network, to a common site. The data can subsequently be downloaded to a data base local to the administration software.

The administration software enables a contest operator to define and run contests involving players of the electronic games. This is a process substantially within the control of the operator. As a result, the operator can take advantage of his market knowledge to create and profit from tournaments or contests that appeal to his player universe.

Embodiments of the present invention are directed to data delivery and management systems and methods for game machines, such as coin or currency operated as well as credit or data card operated video games. For example and without limitation, the games can include games of skill such as sports-related games including electronic golf, basketball, bowling or baseball as well as puzzle games, vehicular driving games, shooting gallery or hunting games.

Systems and methods are provided for the organization and operation of tournaments, contests, or other promotions, involving individual players who have played in one or more of the games of the tournament.

Scores and other game data can be transmitted, via a network, from the members of the plurality of game machines to one or more game servers. The data is stored locally at the game server or servers.

A contest operator can access such data via the network and the game server or servers. The game-related data can be downloaded, via the network, to the operator's computer and local disk drive. The data can subsequently be accessed and organized off-line by the operator using a locally executing, contest creation and administration software tool as described in more detail subsequently.

In one embodiment, data downloaded via the network from the game server to the operator's computer can be processed using local software to determine winners, create reports, and create messages or advertisements. The messages or advertisements can be transmitted back to the game machines, via the server for display thereat.

Game play and machine records can be stored at the game server. They can incorporate player identification, machine status, as well as machine owner or operator information. The game server can obtain the related game up-date information on a predetermined basis, for example, on a daily basis or every other day basis as the respective machines communicate with the game server.

The game owner or operator can access the game server and its data base from another site on the network and download the up-dated game play information. The operator can in turn decide the winner or winners of an on-going contest or tournament, create reports pertaining thereto, create game play volume reports to measure earnings, as well as create messages and/or advertisements to be transmitted to the game machines via the network. The messages and/or advertisements can be displayed on the respective game machines for purposes of promoting on-going tournaments or contests, new tournaments or contests or the like.

In yet another aspect, operators can locally create and store one or more contests or tournaments using the software tool. They can subsequently forward information pertaining to same through the network to the game server. The various game machines will in turn communicate with the server.

The respective tournament or contest can be carried out at the various game machines based on the parameters established by the operator. The operator can download the tournament or contest creation and administration software tool from a remote source, such as the game server via the network.

The Internet corresponds to one form of network. Other types of networks also come within the spirit and scope of the present invention.

Once an operator has become authorized to obtain the creation and administration software tool from the server, such is downloaded to the operator's local computer for storage and execution. The operator can subsequently organize collected game play data obtained via the game server while off-line.

Additional features available to the operator include being able to sort through a number of contests or promotions relatively quickly and easily. Previously created contests or promotions can be stored for re-use subsequent to initial execution. The operator will be able to create, edit and transmit messages and advertisements for presentation at the displays of the various game machines.

One particular advantage of a system which embodies the present invention is that the operator need not communicate directly with any of the game machines. Rather, the operator communicates with the game server and its data base via the network. This communication can be carried out at the convenience of the operator. Subsequently, when the game machines call in from time to time, on automatic basis, they receive information pertaining to new or up-dated contests, new or up-dated messages or advertisements to be displayed in connection with either on-going or future tournaments or contests directly from the game server.

The automatic up-dating takes place in accordance with the various game machines internal schedules which initiate communications with the game server from time to time. The game machines can, as will be understood by those of skill in the art, communicate with the network and the game server via a dial-up communication link, a dedicated communication link, or wirelessly, all without limitation.

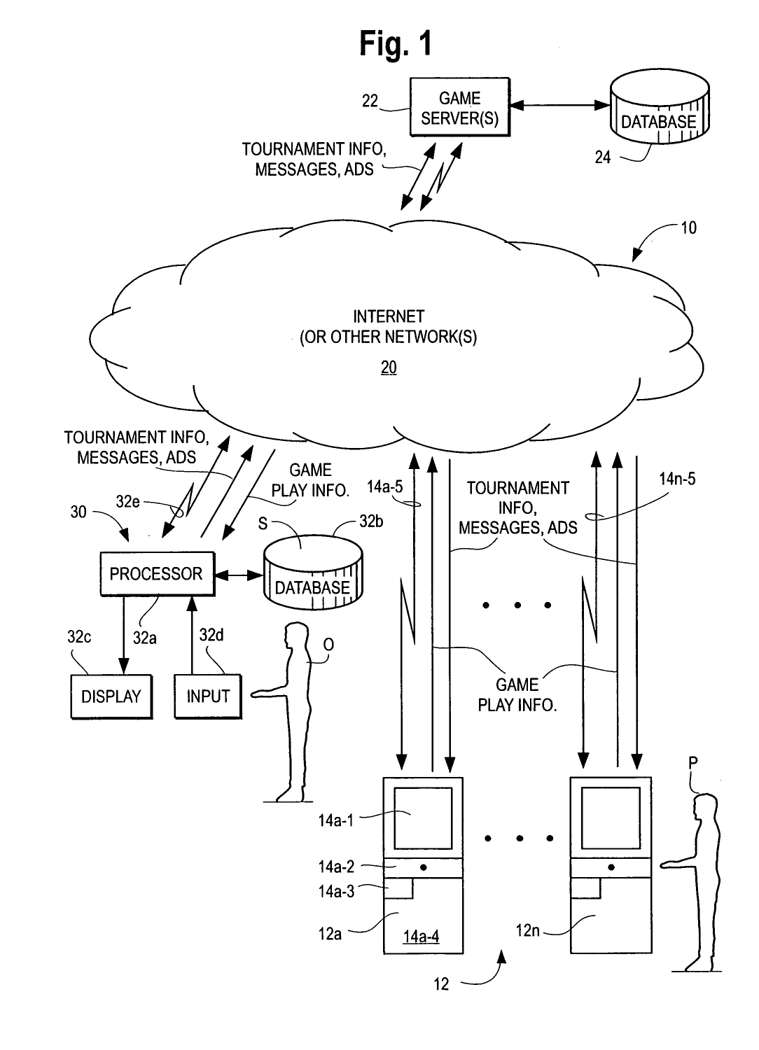

FIG. 1 illustrates a system 10 in accordance with the present invention. The system 10 incorporate a plurality of game machines, which could be substantially the same or could be different, all without limitation, 12a . . . 12n. Each of the machines is designed and intended to enable to enable a player or players P to engage in or play a game of the type provided by such game machines. For example, and without limitation, the game machines 12a . . . n could enable the players P to play various different golf courses as well as games with different rules. Alternately, the machines 12a . . . n could enable the players P to play baseball, bowl, safari or hunt. Other types of games of skill such as vehicular racing, shooting galleries and the like come within the scope and spirit of the present invention.

By way of example, the game machine 12a incorporates a display 14a-1, an operator input interface 14a-2 which might include buttons, switches, track balls, joysticks or the like, all without limitation. A credit establishing device 14a-3 could receive coins or credit cards to authorize use and play of the machine 12a. Finally, control circuitry which includes a disk drive, 14a-4 is carried within the housing of the machine 12a and is coupled to the display 14a-1, input panel 14a-2 and credit establishing mechanism 14a-3.

One type of game machine usable with the system 10 are the GOLDEN TEE brand electronic golf games marketed by the assignee hereof. Subsequent references to golf, golf courses, tournaments, rules or the like, are exemplary only. They are for the purpose of describing embodiments of the invention so as to enable those of skill in the art to make and use same, and for the purpose of disclosing the best mode of practicing same. They are not limitations of the invention.

The machines 12a . . . n can be intermittently linked, via communication channels such as, for example, dial-up telephone lines 14a-5 . . . 14n-5 to a network, such as the internet 20. One or more machines can share a given communication link since none of the members of the plurality 12a . . . n need carry-on continuous communication via the respective link.

The game machines 12a . . . n can initiate bidirectional communication, via the internet or other networks 20, with one or more game servers 22. The game servers 22 support a game-related database 24 which can be periodically up-dated with information by transmissions initiated via one or more of the game machines 12a . . . n.

The game server 22 can in turn download to the respective game machines 12a . . . 12n information temporarily stored in database 24 when the respective game machine communicates with the server 22. It will be understood that communication details between the game machines 12a . . . 12n, network 20 and game server 22 are not limitations of the present invention.

It will also be understood that game play information or data from the respective game play machines 12a . . . 12n is up-loaded to the server 22 and database 24, via network 20, only on an intermittent basis when the respective game machine initiates communication with the server. At other times, the communication link associated with the respective game machine is not used by that game machine and is available for use by other game machines.

An operator's computer system 30 incorporates a processor 32a, associated with database 32b, display 32c and input devices such as keyboards, touchscreens, track balls, mice and the like 32d, all without limitation. The operator computer system 30 can be placed into intermittent communication via the network 20, over a link 32e with game server 22. In this circumstance, game play information up-loaded from the game machines 12a . . . n stored in database 24 can be downloaded by the link 32e to the operator's computer 30 for local storage in database 32. Once the operator 0 has obtained the necessary information, he/she can operate off-line to carry out various of the functions as described below.

Player information can be retrieved from server 22. Messages and leaderboards can be sent, via the network 20 directly to online machines 12a . . . n.

Operator software S executed at processor 32a enables the operator or owner to create a variety of contests and promotions. If desired, the software tool S could be downloaded from server 22 and stored locally 32b for execution at the operator's convenience.

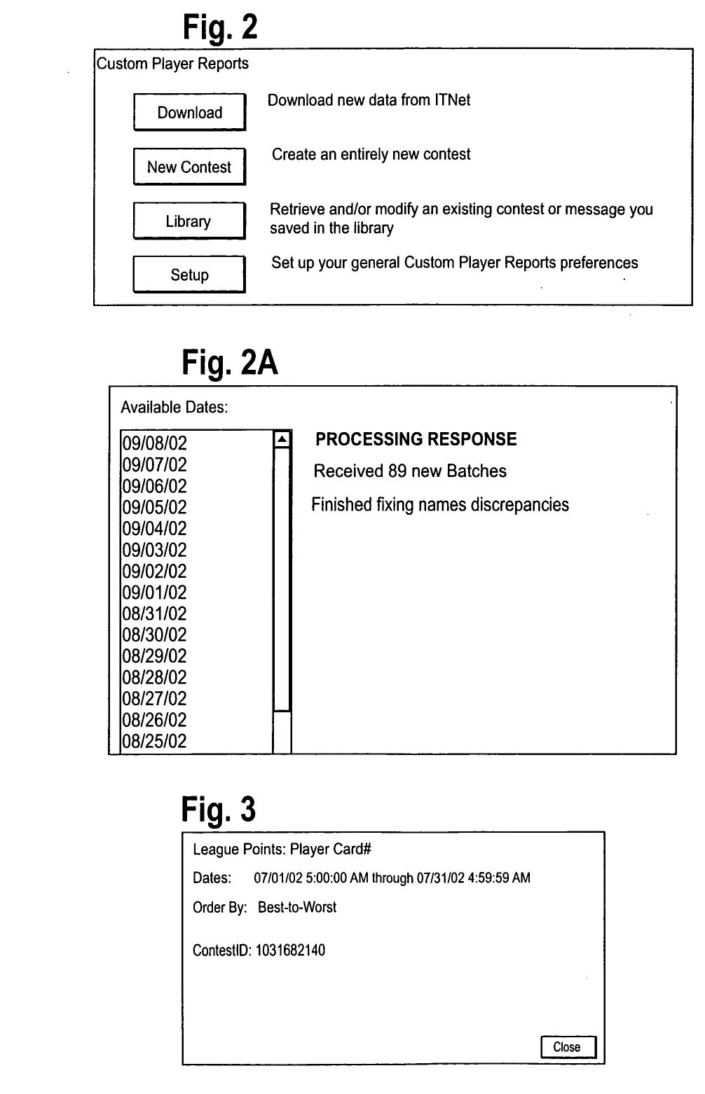

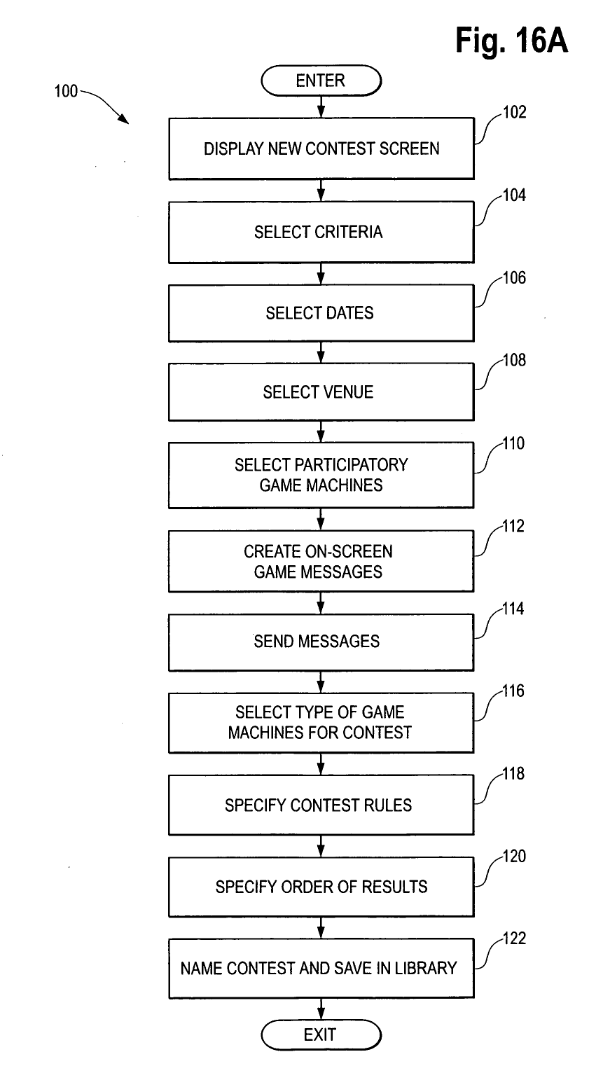

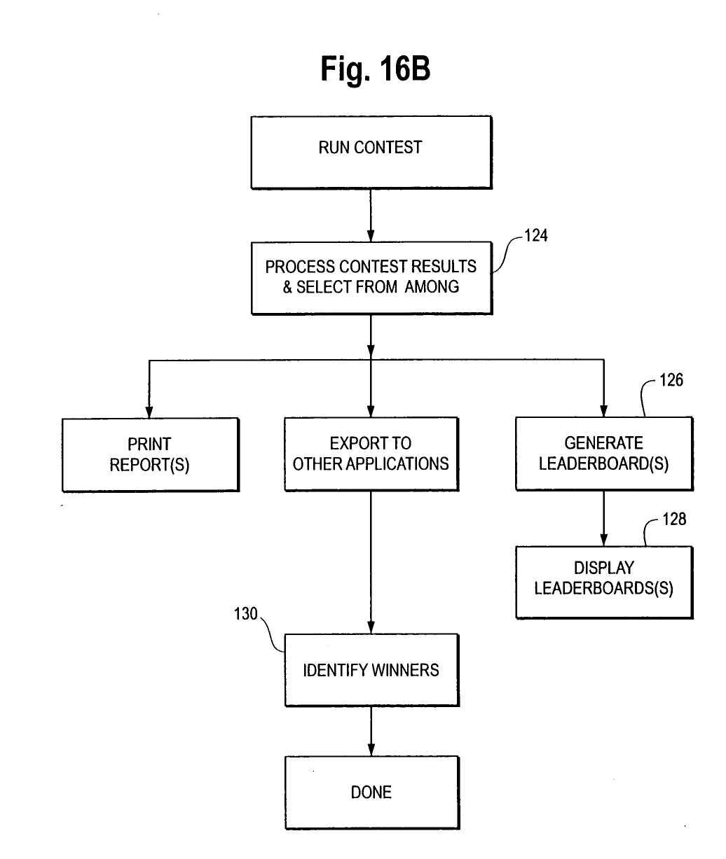

The following FIGS. 2-15A illustrate a variety of graphical displays or screens produced by software S and presented to the operator O. Operator O can interact with software S by using keyboard, mouse or trackball, or other input devices, to enter information or “click” on various lighted buttons or control elements as would be understood by those of skill in the art. FIGS. 16A,B illustrate additional details of a method of creating contests or tournaments.

It will be understood that neither the programming language nor the exact details of software S are limitations of the invention. Variations in the graphiacal displays of FIGS. 2-15A also come within the spirit and scope of the invention.

Using software S an initial menu of options, see FIG. 2 can be presented to the operator O. The following exemplary functions are available to the operator O. Additional or alternate functions could also be included without departing from the spirit and scope of the invention. The “Download” button allows retrieval of game machine data from server 22. The “New Contest” button presents all the criteria needed to set up a new contest or promotion. “Library” is where previously saved contests are stored. “Setup” establishes preferences when using the software S.

Downloading game machine data: Periodically new data from machines 12a . . . 12n is stored at server 22 and made ready for downloading to computer 32a. Clicking the “Download” button on the menu begins a transfer of new data to computer 32a and database 32b, see FIG. 2A. Once the download is complete, the operator can disconnect from the network 20 and work off-line using the other features of the softwares to create reports, define new contests or evaluate on-going contests.

To download the latest play data, the operator's tool S sends the operator's ID and password, along with a list of dates from a “batches” table (representing days for which data has already been downloaded) to server 22. When a reply is received from the server 22, the program S checks to see if the password was accepted. If so, new data is added to both a main data table and the “batches” table in database 32b.

These batches include, for example, a collection of all the shot, score, and player data that the operator's machines have collected in the last time period, for example, 24 hours.

The server 22 can send software S a list of all games currently registered to the operator. If the game machines are configured for example, as golf playing machines, a list of all standard courses and all tournament courses for the operator's country can be sent to computer 32a. In alternate configurations, a list of stadiums could be sent to computer 32a.

The “Library” selection enables the operator to retrieve saved contests and messages. To review the contest criteria, the contest is highlighted and the “Describe” button is clicked. This feature allows the operator to view the contest criteria, and date ranges, see FIG. 3. In addition, it will also be denoted if a group of winners has been saved in a winner's bracket. This makes it very easy to sort through a large quantity of contests very quickly.

If the operator has opted to create a contest and sort out previous winners, any winner data that is saved can be cleared. The “Open” button can be used to open this contest and change or adjust criteria. Finally, a saved contest which is no longer needed may simply be highlighted and deleted from the library.

When the contest is opened from the library, the operator's program S retrieves all information related to this contest from the “library” table. It then proceeds to simulate user's input to rebuild a contest using retrieved information.

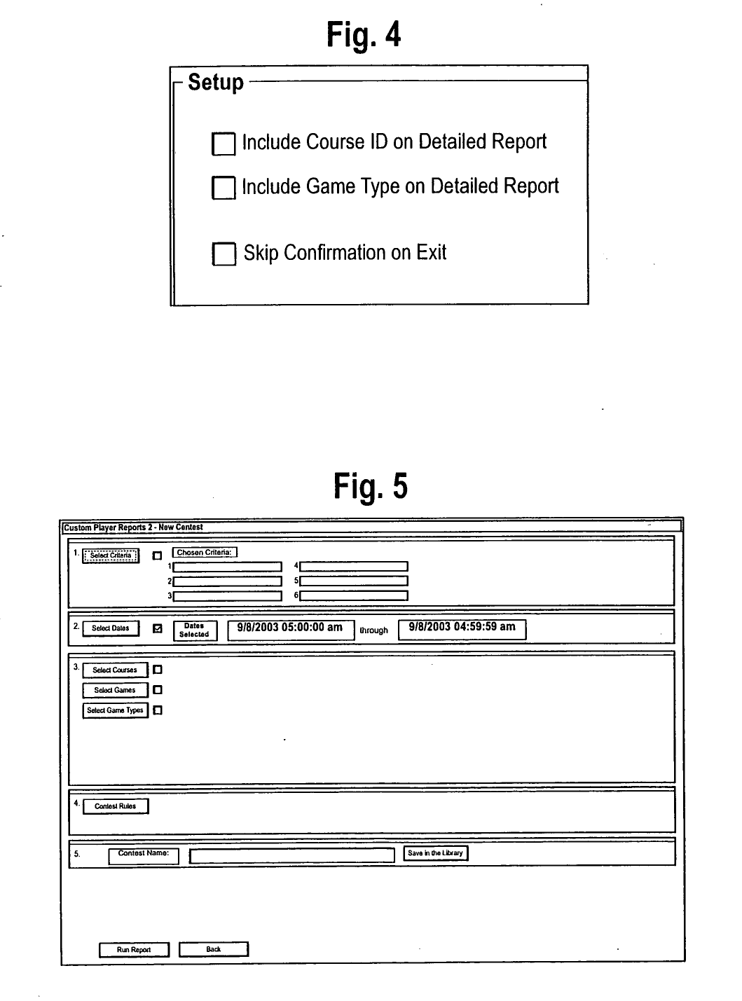

In the Setup section, FIG. 4, some default categories are listed, including the game type and course ID. To suppress some or all of this information, the check box next to each entry is deleted. Data no longer required for contests can be deleted. Additonally, by selecting a date on a pop up calendar and then clicking a “Delete” button, all data prior to the date selected can then be permanently deleted across all of an operator's machines.

Clicking on a “Show Postings” button that can be displayed at the bottom of the page allows an operator to manage the on-screen messages such as ads or leaderboards that have been sent to that operator's games. On this screen the operator will be able to see a brief per game description of the posts being sent to machines. This screen may be used to track and delete these messages.

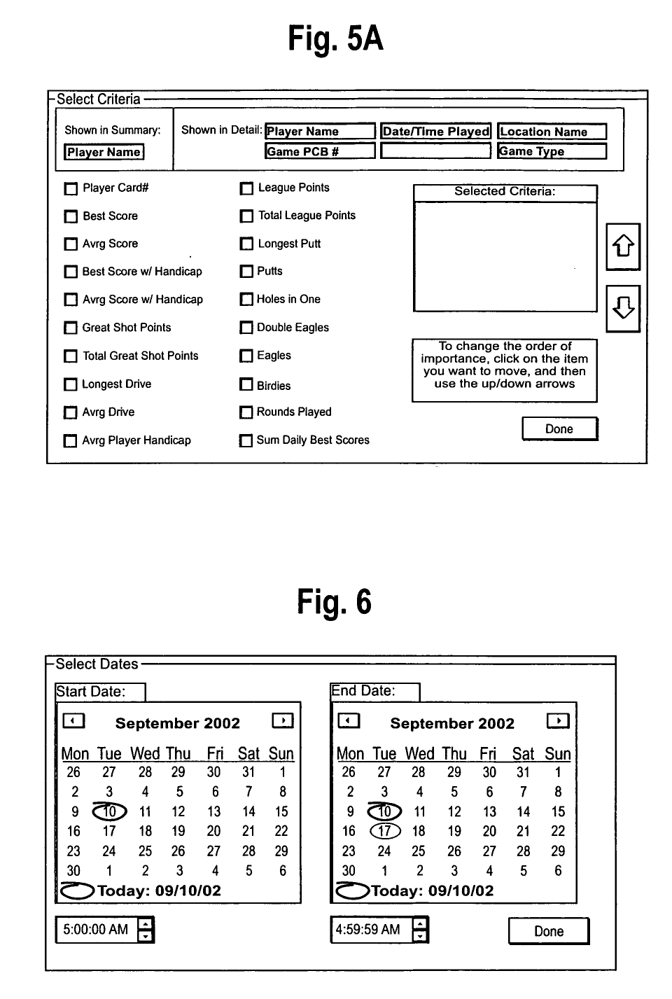

In the “New Contest” section the criteria that will determine the outcome of a new promotion or contest can be selected, FIG. 5. Click on “Select Criteria” to open the selection menu, see FIG. 5A which illustrates choices for an exemplary golf tournament. It will be understood that this screen would vary depending on game type. Such variations are not a limitation of the invention.

A variety of different categories can be selected, see FIG. 5A, including:

| | |
|---|---|
| Best Score | Eagles |
| Average Score | Birdies |
| League Points | Putts |
| Total League Points | Longest Drive |
| Great Shot Points | Longest Putt |
| Holes-in-One | Handicap |

The operator can adjust the order of priority of these criteria by highlighting one of the entries and using the arrow to move it up or down in the list. The sort order is important when retrieving contest data that matches contest rules.

The “Sum Best Daily Score” selection allows the operator to view an over-all score for a layer throughout the entirety of a given contest. This over-all score is a player's best core from each day of the contest totaled together for a grand total score. For example, relative to the exemplary golf game, a player receives a −2 the first day of the contest, then the player returns on the second day and receives a −3. The player's Sum Best Daily Score would then be a −5. No matter how many games are played, only a player's best score from each day is counted toward the “Sum Daily Best Score”.

In the criteria selection process, the program S checks the validity of the operator's input (i.e. at least one field is selected, no more than 6 fields are selected, etc.) When it is done, the program flags and remembers the operator's input. The program also marks this segment of data input as “completed”

The operator can select the dates to be reviewed by using the popup calendars, FIG. 6. Click on the date the promotion should start, and the date promotion should end. The time of day that the contest begins and ends can also be set.

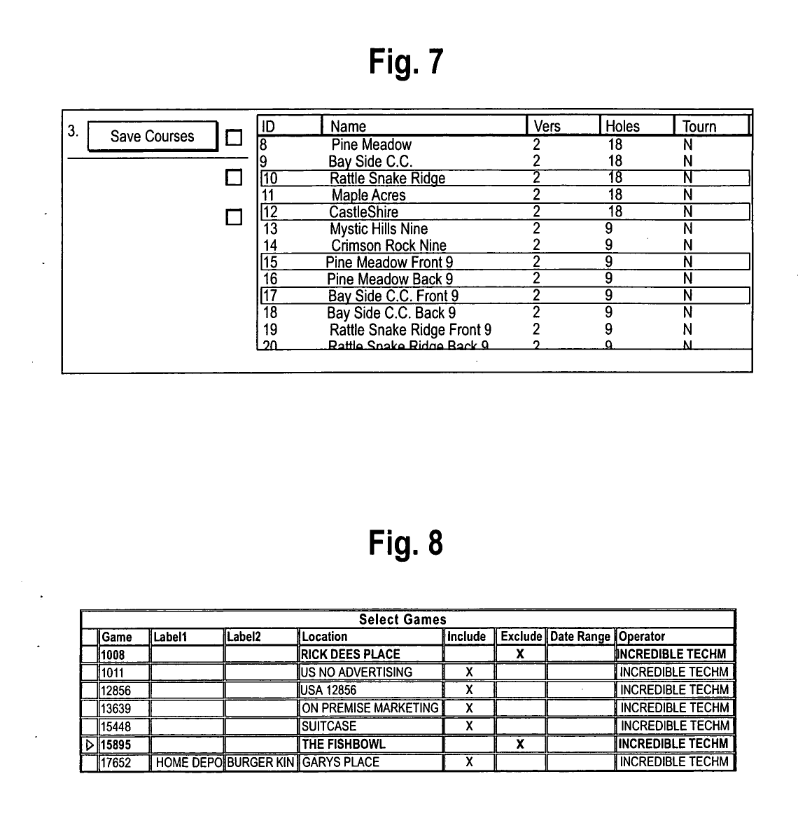

The tool S checks the validity of user's input (end date is later than start date). When done, the program S remembers user's input. The tool S then marks this segment of data input as “completed”.

Where the game machines 12a . . . n are designed to enable a user to play a game of golf. the operator can impart realism to the contest by selecting an appropriate course or courses to be played. As illustrated in the screen of FIG. 7, a variety of courses can be selected by the operator. For a baseball game, stadiums can be selected.

In the process, the program S checks the validity of the user's input (i.e. at least some courses are selected). When the process is finished, the program remembers the user's input. The program also marks this segment of the data input as being “completed”.

The “Select Games” screen, FIG. 8, lists each game machine's serial number, along with its assigned labels, and its location name. Next to the location name are three buttons: “Include”, “Exclude”, and “Date Range”. In the disclosed embodiment, by default, with one exception, all of games should come up defaulted to the “Include” position. It will be understood that other default options could be chosen.

The only exception deals with games that are no longer in inventory, but were previously online. These machines will default to the “Exclude” position since they are no longer in inventory and it is not possible to run an on-going contest with them. By leaving the game machine included and active, the game will remain in the contest, and receive any on-screen messages and leaderboards sent by the operator. Excluded games will not be included in this contest and messages will not be sent.

The “Date Range” feature can be used if a game can only be involved in a contest for a limited time. By selecting the Date Range option, the operator will be able to set an active date range for each game. Once the end date is reached, the machine will be removed from the promotion automatically.

In the process, the program S checks the validity of user's input (at least some games are selected, date ranges do not contradict each other, etc). when done, the program remembers user's input. Program S also marks this segment of data input as “completed”.

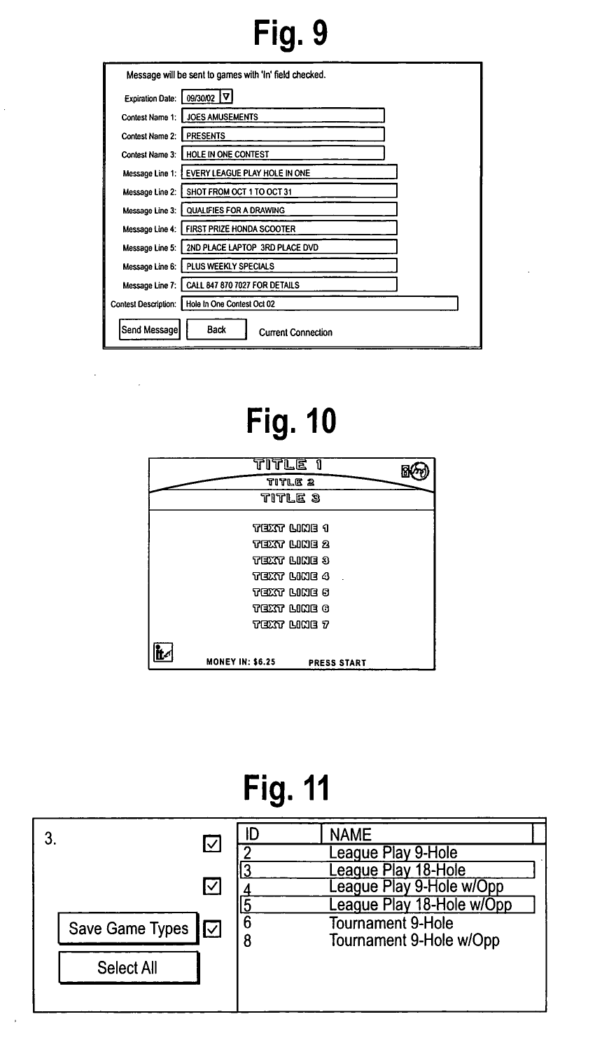

After deciding which games will be involved in a given contest, the operator can then send on-screen advertising to promote the contest. By pressing the “Create On-Screen Message” button located at the bottom of the “Select Games” screen. A window will pop-up, FIG. 9, that will allow the operator to fill out various text fields and set an expiration date for the message.

The text entered in these fields will show up on the actual game screen, such as 14a-1 of the respective game machine, 12a for example. The expiration date will be the date the message is removed from that machine. The Contest Description line is a label to keep track of various sent messages. Clicking the “Send Message” button will send the advertising screen to the server 22.

Program S sends the operator's ID and password, followed by an on-screen message expiration date, along with 2 title lines, and 7 text lines to screen 22. When a reply is received, the program S displays the status of the transmission (i.e. whether it was successful or not).

The program S sends the server 22 a message containing “Posting Type,” an “Identification Number,” and a “Type” flag indicating if this is an advertising or a leaderboard and which list of games are supposed to receive the posting.

The server 22 authenticates the operator by comparing the Operator ID and password sent from the tool to the values stored in the database 24. The server 22 then checks to see if this posting exists in the database, if it does not exist, the server stores the posting information in the database 24.

The server 22 loads the new list of game units into the database 24. A process is run on the database that checks to see if any games that were previously sent these postings have been deleted, if any new games have been added, and if any games that have been added now have more postings assigned to them hat is allowed (these games are bumped”). The process then adjusts for any games that were removed from the posting or bumped, and adds any new games.

The server 22 then updates the posting text in the database 24, and sets the date on the posting so that it will be sent to the game machine 12a . . . n on the next call. When the game machine calls in, the server 22 sends the game a list of postings the game should have and the date those postings were updated.

The game machine then compares the list of files to the files on its hard drive and requests that the server 22 send it any postings it does not have and any postings that have been updated. For each posting the game requests, the server 22 takes the appropriate information from the database 24 reformats it, and sends it to the game machine.

The Server 22 sends the game machine a list of postings that it has and the ones that should be removed. The game machine then deletes these files from its hard drive.

Contest message screens will be displayed on all of the selected games, display 14i-1, after the next successful call to server 22. This screen, best seen in FIG. 10, will appear as part of the attract sequence when the machine is idle. Players can jump right to this screen by inserting an identification card into the card reader, 14i-3.

This messaging system can be used for a wide variety of purposes. Contest dates, format and prizes, can be advertised. In addition, special pricing, location specials, or local events can be advertised. If desired, other products or services can be advertised.

The operator can then select the various game types to include in this promotion, FIG. 11. For example, if the contest involves best score on a course, only including 18-hole games may be appropriate. Or, for a more skill-based contest, “blind” play only might be included. Other game machines, such as games played with the on-line opponent could be excluded.

In the process, the program S checks the validity of the user's input (i.e. at least some game types are selected). When the process is completed, the program S remembers the user's input. The program S also marks the segment of data input as having been “completed”.

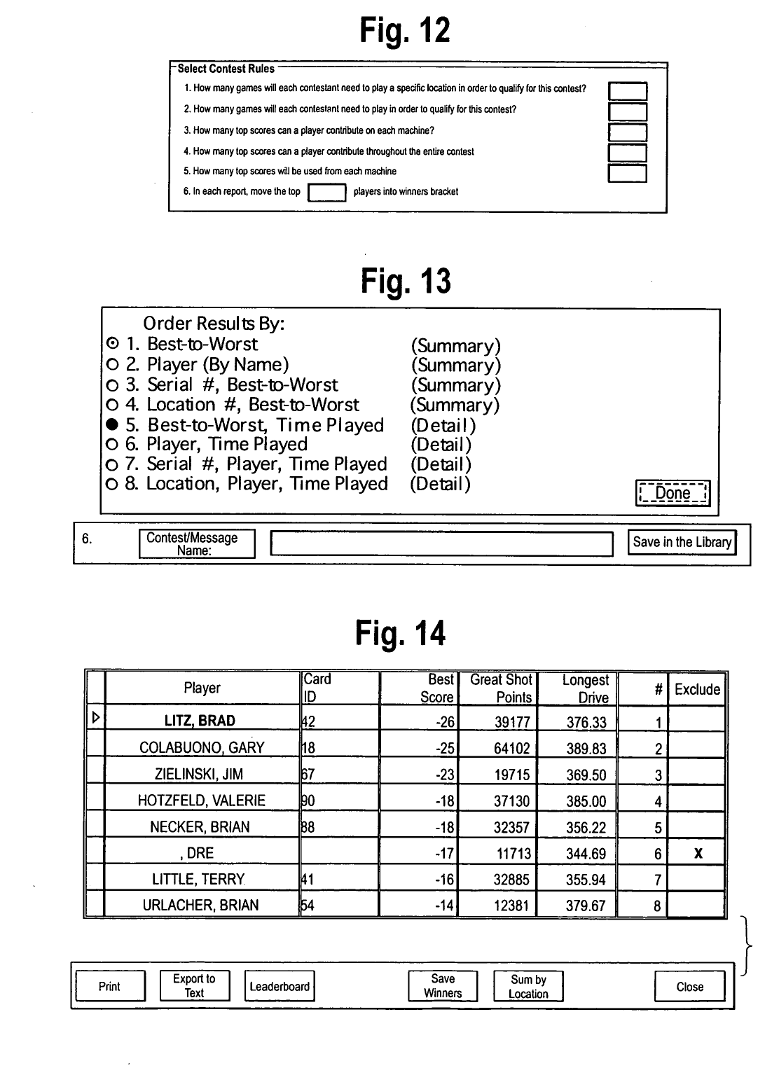

Special rules can be applied to the contest. By pressing the “Contest Rules” button, a screen FIG. 12 with a list of features that will affect the way the contest functions will be displayed. These include, by way of example:

Specifying how many games will each contestant need to play at a specific location in order to qualify for this contest. This option allows the operator to set a required amount of games that each player must play in a single location before their results are counted. For example, by electing to have five games set as a minimum, all players must play five games in a specific location before any results are considered;

Specifying how many games will each contestant need to play in order to qualify for this contest. This option allows the operator to set a required amount of games that each player must play before their results are counted. For example, by electing to have five games set as a minimum, all players must play five games before any results are considered;

Specifying how many top scores can a player contribute on each machine. As an example, if this field is set to ten, each player could play as many games as they wanted, but on each machine, only the top ten scores from each player will actually count toward the contest;

Specifying how many top scores a player can contribute throughout the entire contest. This feature is similar to the above except it is not machine specific. By setting this field, each player(s) can play as many games as they want on each machine. However, the results will be limited to their top “X” scores over-all;

Specifying how many top scores will be used from each machine in this contest. Setting this field determines the number of records each machine can post. As an example, only the top 10 scores from each machine will count towards the contest; and

Specifying in each report the number “X” of top players to be moved into the winners bracket. The tool S can automatically ignore the top “X”: number of players from the last time the contest was run. In this way, the operator can hold qualifying rounds and guarantee that different people can move up into the next winners bracket.

The operator can then choose how to display final results under “Order Results By”, see FIG. 13:

By default, all contests will sort results in a simple summary “best-to-worst” order, only listing the player name and the promotion results. If the operator wishes to change the way results are displayed, one of eight different options can be selected.

1. Best-to-Worst (Summary)—This is the default selection described above. This report lists each person sorted by operator criteria in best-to-worst order.

2. Player-By Name (Summary)—This will sort all contest results in alphabetical order by player name.

3. Game, Best-to-Worst (Summary)—Sorts the report first by game unit, and then ranks all the players that played on that game.

4. Location, Best-to-Worst (Summary)—If there are multiple games to a location, this sort allows operator to sort first by location name, grouping all the games in that location together, and then all players are sorted in standard Best-to-Worst order.

5. Best-to-Worst, Time Played (Detail)—Choosing this option sorts each player in best to worst order, but shows every individual game that was played.

6. Player, Time Played (Detail)—This option will sort all results alphabetically, and list every game each competitor played.

7. Game, Player, Time Played (Detail)—Sorts first by game unit, and then lists all players alphabetically on each machine along with every single game they played.

8. Location, Player, Time Played (Detail)—If there are multiple games at a location, this sort enables the operator to sort first by location name, grouping all the games in that location together, and then all players are listed alphabetically along with every single game they played.

During this process, the program S checks the validity of the user's input (for example, certain combinations of Contest Rules and Sorting Order are not allowed). When done, the program S remembers the user's input. The program also marks this segment of data input as “completed”. Other sort criteria could also be defined.

Once an operator has selected all contest criteria, the contest is named and saved by clicking the “Save in the Library” button. The contest will then be available for future reference.

The program S checks that the Contest/Message name is valid. Next, the program checks for the presence of a Contest/Message with the same name in the library table. If the program S finds either a contest or message of the same name, the program allows the user either to change the current name or to overwrite the existing Contest/Message in the library with the new one.

After saving a contest in the library, the operator can run the contest results. The “Run Contest” button can be used to retrieve contest data the contest data will be sorted based on operator selected criteria.

The program S checks to see if segments of the data have been marked as “completed”. If so, program S copies the main data table into a temporary output table. It then limits the output table to records that the satisfy conditions specified by the operator. In this exemplary embodiment, the sequence executes as follows:

Exclude all records with player name “UNKNOWN”

If any fields related to handicap were selected, exclude all records without a handicap

If the “exclude winners” option was selected, exclude all records with prior winners

Exclude records outside of the selected time period

Exclude records with courses outside of the operator's selection

Exclude records with games outside of the operator's selection (games permanently OFF)

Exclude records where game-time played combination is outside of the operator's selection (games with ON-OFF date range)

Exclude records based on contest rules

After running through all of the variables, the program S displays an output table, FIG. 14. Various options are available to the operator.

Print—This allows operator to send the results of the current promotion results to a printer. The operator can add a header and footer, and format data to fit page size for posting the results.

Export to Text—Use this option to edit results or import them into another application. The file is stored as a .txt file, which can be readily imported into programs like EXCEL, ACCESS and WORD. The text file will be saved to the local drive of computer 30.

Leaderboard—This button allows operator to generate a leaderboard from results and send it back to the games involved in the contest. When this option is selected, depending on criteria, three different leaderboard choices are available: Standard Leaderboard, Location Specific Leaderboard, and Game Specific Leaderboard.

The Standard Leaderboard option sends the same leaderboard to every game included in the contest. The Location Specific Leaderboard will send an individual leaderboard to each location. A location can have more than one machine, and all machines in this location will share a common leaderboard. Location names assigned to the machines at a location must be identical.

The Game Specific Leaderboard will send an individual leaderboard to each game in the contest, regardless of its location. The operator will be able to choose Game Specific and Location Specific Leaderboards if he/she initially chose to use the game and location specific Display Order options.

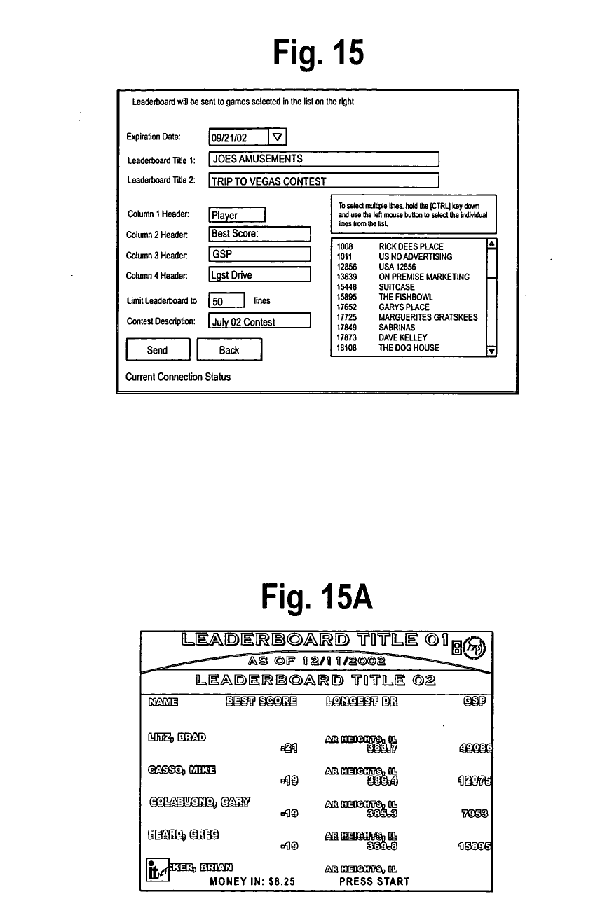

Once a leaderboard type has been selected, a new menu, FIG. 15 can be displayed. The new menu allows various leaderboard text fields to be filled and can set an expiration date for leaderboard.

The text in these fields will show up on the actual game screen of the machines and the expiration date will be the date the message is removed from those machines. The Column Header fields will directly correspond to selected criteria and will represent the titles or headers at the top of the game Screen With Example.

The Limit Leaderboard field is the amount of results that will be allowed to show on the game screen itself. This field defaults to 50 lines of text, but operator can shorten or lengthen. To send leaderboards to the machines, the Send button is clicked.

The program S sends the operator's ID and password, followed by any information related to the leaderboard.

For a standard leaderbord, the sent information can be structured as follows:

The general leaderboard information (expiration date, titles, headers, etc)

List of games to receive leaderboard Report

For a location-specific leaderboard the sent information can be structured as follows:

General leaderboard information (expiration date, titles, headers, etc)

The list of games in each location

The portion of the report related to that particular location

(These steps are repeated for each game included in the report)

When a reply is received from the server 22, the program S displays the status of the transmission.

The leaderboard will be displayed on the respective game machines the next time they make a successful call to server 22, see FIG. 15A. The leaderboard is pre-formatted and will scroll from bottom to top. Players can access this leaderboard by inserting their identification card into the card reader during the attract mode.

In the Select Options section of the software S, FIG. 12, an operator has the ability to select the number of winners to move up into a winner's bracket. By utilizing the “Save Winners” option, the operator has the ability to choose new and different winners each time.

By choosing option #8, “Order by” (Location, Player, Time Player), FIG. 13, the “Summary by Location” option will become active on the report result screen. Clicking this button will bring up a location list along with the number of plays attributed to each establishment.

FIG. 16A is a flow diagram of a process 100 for defining a new contest. A new contest definition screen is displayed for an operator, step 102, see FIG. 5. Using the facilities of the screen of FIG. 5, the operator displays a select criteria screen and defines the specific criteria for the new contest, step 104, see FIG. 5A. Subsequent to defining the contest criteria, contest dates are selected in a step 106, see FIG. 6. In a step 108, contest venues are selected such as golf courses, baseball or football stadiums or the like, 108, see FIG. 7. The specific machines which are to participate in the contest, step 110, see FIG. 8.

Subsequent to specifying the particular machines to participate in the contest, the operator can create on-screen messages to be transmitted to and displayed on the screens, such as the screen 14a-1 of the respective game machines such as the machine 12a. In a step 112, on-screen messages are defined, see FIG. 9. The defined on-screen messages can then be sent to the respective game machines, step 114. In a step 116, the operator can specify the type of game machines at the various locations which will be permitted to participate in the contest, see FIG. 11.

Contest rules can be selected and specified in step 118, see FIG. 12. The contest results can be ordered or sorted in a step 120, see FIG. 13. The contest can be named and saved in the library, step 122.

Subsequently, the contest can be run with players P interacting with the appropriate plurality of game machines 12a . . . n. Relative to FIG. 16B, contest results can be processed by the operator in a step 124, see FIG. 14. Displayed contest data will have been sorted based on the previously specified orders of results, see step 120, FIG. 16A. The operator will then have the option of printing current results, importing the results to another application (export to text capability) or, generating leaderboards, step 126, see FIG. 15. The leaderboards can be downloaded to the various game machines and subsequently displayed, step 128. Finally, in step 130, contest winners can be identified.

It will be understood that other variations are possible without departing from the spirit and scope of the invention. For example, a game 12a could incorporate a server. In this instance, the server in the game machine 12a could be in communication with the server 22 via the network. Alternately, server 22 could be incorporated into the game machine 12a and communicate with the remaining game machines 12b, c . . . n via the network. Such communications could be with wired interconnects, such as switched phone lines or dedicated high speed lines. Alternately, communications could be wireless as would be understood by those of skill in the art.

It will also be understood that Labels, see FIG. 8 can automatically form the basis of selecting a group of games for a contest. Operator O can direct software S to sort games by their respective Label(s). Those games with the specified Label(s) can be automatically included in one or more contests.

The operator O can specify screens to select various classes of winners. For example, the top ten or twenty prior winners of a prior contest or contests can be automatically selected as eligible for a “winners” contest. In this fashion, participation can be automatically limited to a specified subset of available players.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A method of conducting multi-player contests where the contestants participate via video game, the method comprising:
arranging for a plurality of contestants to interact with the video game thereby producing respective contestant data associated with each contestant;
up-loading at least some of the contestant data to at least one selected location for storage;
downloading at least part of the contestant data to a second location and combining the downloaded data with additional data for storage at the second location;
formatting at least some of the data at the second location to facilitate determining which contestant should be declared a winner of the contest.

2. A method as in claim 1 which includes establishing a set of criteria usable to determine the winner of the contest.

3. A method as in claim 1 which includes up-loading data pertaining to the winning contestant from the second location to the at least one location for storage.

4. A method as in claim 3 which includes down-loading data pertaining to the winning contestant to the video game and presenting same thereat for review by an audience.

5. A method as in claim 1 which includes selecting some of the contestant data from available contestant data at the second location.

6. A method as in claim 5 where the formatting process includes arranging the requested data in a predetermined configuration.

7. A method as in claim 5 where the selected contestant data originates during a predetermined time interval.

8. A method as in claim 5 which includes providing, at least intermittently, a communications path for up-loading the contestant data.

9. A method as in claim 8 where contestant data includes contestant identifier, game identifier and game play data.

10. A method as in claim 9 including formatting respective information into a plurality of game play records.

11. A method as in claim 10 including associating selected game play records with a common video game owner.

12. A method as in claim 10 which includes down-loading contest results to a plurality of video games.

13. A method as in claim 12 including presenting contest results at respective video games.

14. A method as in claim 12 including forming and downloading visual indicators concerning contest results to respective video games.

15. Software recorded on a computer readable medium comprising:
software enabling a user to specify data pertaining to results of carrying out of a pre-specified contest, or promotion;
software to obtain updates of the specified data, the updates correspond to contest or promotion data accumulated during a selected time interval, from a displaced source;
software to format the data in accordance with user inputs.

16. Software as in claim 15 permitting the user to specify contest or promotion determining criteria.

17. Software as in claim 16 to prioritize the criteria.

18. Software as in claim 16 to specify a contest or promotion time frame.

19. Software as in claim 16 enabling the user to select one of a plurality of games for a contest.

20. Software as in claim 15 enabling the user to specify features of the contest or promotion.

21. Software as in claim 20 enabling the user to forward contest or promotion features for presentation at a plurality of locations.

22. Software as in claim 21 enabling the user to forward contest results to the plurality of locations.

23. Software as in claim 15 permitting a user to log on.

24. Software as in claim 15 enabling the user to receive performance information from at least one coin operated video game.

25. Software as in claim 15 which enables a user to incorporate advertisements or promotional materials into player perceivable displays at a plurality of spaced apart, coin operated video games.

26. A system for management of contests among players at a plurality of spaced apart, video games, the system comprising:
circuitry enabling a manager to specify features of a contest;
circuitry enabling the manager to forward at least some contest features for display at a plurality of video games;
circuitry enabling the manager to conduct the contest during a predetermined time interval;
circuitry enabling the manager to define at least one report relative to performance of the players in the contest;
circuitry enabling the manager to obtain game play data for the report.

27. A system as in claim 26 which includes executable instructions enabling the manager to define and forward advertisements to at least some of the games.

28. A system as in claim 27 with instructions to store characteristics of a plurality of different contests

29. A system as in claim 28 with instructions to retrieve and revise a pre-stored contest.

30. Game tournament administration software recorded on a computer readable medium comprising:
first software enabling an operator to create a contest.
second software enabling the operator to create and to transmit contest promotional announcements to a plurality of spaced apart game machines;
third software enabling the operator to post game results on at least some of the game machines which participated in the contest.

31. Software as in claim 30 which includes additional software enabling the operator to define at least one report, and, to retrieve contest game play related information from at least one displaced source.

32. Software as in claim 30 which includes additional software enabling the operator to specify at lest one contest winner and to transmit winner related information to at least some of the game machines which participated in the tournament.

33. Software as in claim 30 which includes additional software enabling an operator to transmit at least one advertisement to a second plurality of spaced apart game machines.

34. Software as in claim 30 which includes additional software to create and store a plurality of different tournaments.

35. A contest management system, software recorded on a computer readable medium, the system comprising:
first software to obtain up-dated game play data from a remote data base, via an electronic network;
second software to up-date a local data base with the updated game play data;
third software for identifying a selected, on-going contest and for viewing contest status;
fourth software for creating at least one contest status message and for forwarding it to a plurality of spaced apart games via the network.

36. A system as in claim 35 which includes fifth software for defining a new contest.

37. A system as in claim 35 which includes additional software for creating at least one advertisement and for forwarding it to be displayed on a plurality of spaced apart games via the network.

38. A system as in claim 35 where the fourth software comprises additional software to create game specific messages identifying selected participants n the contest.

39. A system as in claim 38 where the additional software accesses the local data base and extracts game specific information therefrom for use with the game specific messages.

40. A system as in claim 38 where the game specific messages comprise leader boards for a predefined golf tournament.

41. A system as in claim 39 where the game specific messages comprise information relating to status of players of a game of skill participating in a contest.

42. A system comprising:
a plurality of network enabled games of skill;
at least one game server with a data base in at least intermittent communication, via an electronic network, with the members of the plurality, the members of the plurality providing contestant performance information to the database as to an on-going, predefined contest;
computer executable contest administration software which at least intermittently accesses the database via the electronic network, for updated contestant performance information including software which enables an operator to visually review contest status information while off-line.

43. A system as in claim 42 where the administration software includes software to create contest-related promotional messages and to forward the messages to the game server for subsequent downloading to, and, display by at least some of the games.

44. A system as in claim 42 where the administration software includes software to create contest-related status messages and to forward the messages to the game server for subsequent downloading to, and, display by at least some of the games.

45. A system as in claim 42 where the administration software includes contest definition software to create and store a new contest.

46. A system as in claim 45 which includes software for downloading information as to a newly created contest to at least some of the games.

47. A system as in claim 46 where the administration software comprises additional software to create advertisements to be downloaded via the network, to and displayed on at least some of the games.

48. A system as in clam 47 where the games comprise one of a sports game, a hunting game, a puzzle or a vehicular driving game.

49. A system as in claim 48 where the sports game comprises a golf game with the contest comprising golf tournaments.

50. Video game contest management software recorded on a computer readable medium comprising:
software to update a data base of contest related game play information; and
software to create and save a plurality of video game related contests.

51. Software as in claim 50 which includes additional software to create messages for presentation at a plurality of displaced video game machines.

52. Software as in claim 50 which includes additional software to establish contest defining rules.

53. Software as in claim 50 which includes additional software to establish indicia associated with respective video game machines for grouping machines according to at least one criteria.

54. Software as in claim 51 where the additional software enables a user to create at least one of an audio message or a video message.

55. Software as in claim 50 including additional software for intermittent communication with a displaced data base and for transmission of messages for storage at that data base for subsequent presentation at selected game machines.

56. A system comprising:
a plurality of network enabled games of skill;
at least one game processor with a data base in at least intermittent communication, via an electronic network, with at least some of the members of the plurality, the members of the plurality providing contestant performance information to the database as to an on-going, predefined contest;
computer executable contest administration software which intermittently accesses the database via the electronic network, for updated contestant performance information including software which enables an operator to visually review contest status information while off-line.

57. A system as in claim 56 where the administration software includes software to create contest-related promotional messages, while off-line and to forward the messages to the game processor for subsequent downloading to, and, display by at least some of the games.

58. A system as in claim 57 where the administration software includes software to create contest-related status messages and to forward the messages to the game processor for subsequent downloading to, and, display by at least some of the games.

59. A system as in claim 57 where the administration software includes contest definition software to create and store a new contest at a second, different data base.

60. A system as in claim 59 where the administration software includes additional software for downloading information as to a newly created contest to at least some of the games.

61. A system as in claim 60 where the administration software comprises additional software to create advertisements to be downloaded via the network, to and displayed on at least some of the games.

62. A system as in clam 61 where the games comprise one of a sports game, a hunting game or a vehicular driving game.

63. A system as in claim 62 where the sports game comprises a golf game with the contest comprising golf tournaments.

64. A method as in claim 1 which includes analyzing a received request and in response thereto selecting the requested contestant data from available contestant data at the second location.

65. A method as in claim 64 where the formatting process includes arranging the requested data in a predetermined configuration for a requester.

66. A method as in claim 64 where the selected contestant data originates during a predetermined time interval.

67. A method as in claim 64 which includes providing, at least intermittently, a communications path for up-loading the contestant data.

68. A method as in claim 67 where contestant data includes contestant identifier, game identifier and game play data.
